(19) United States
(12) Patent Application Publication
(10) Pub. No.: US 2026/0277470 A1
(43) Pub. Date: Sep. 17, 2026

(54) SHARED MEMORY OPTIMIZATION THROUGH HARDWARE-IMPLEMENTED CIRCULAR BUFFER

(71) Applicant: NVIDIA Corporation, Santa Clara, CA (US)

(72) Inventors: Chao Li, Austin, TX (US); Karl Andreas Sembrant, San Jose, CA (US); Ronny Krashinsky, Portola Valley, CA (US); Manan Patel, San Jose, CA (US); Maciej Tyrlik, Durham, NC (US)

(21) Appl. No.: 19/355,061

(22) Filed: Oct. 10, 2025

Related U.S. Application Data
(60) Provisional application No. 63/770,903, filed on Mar. 12, 2025.

(51) Int. Cl. G06F 3/06

(52) U.S. Cl. CPC G06F 3/0656; G06F 3/0604; G06F 3/0673

(57) ABSTRACT

Apparatuses, systems, and techniques for shared memory optimization through circular memory buffers are disclosed herein. The system may include an address generation unit to generate addresses for a single matrix operation that processes data spanning non-contiguous buffers in shared memory. The address generation unit may store a first buffer address and a second buffer address and coordinate access to both buffers for the single matrix operation. The system may include boundary detection logic to determine when the single matrix operation requires data from multiple buffers. The system may support matrix operations that process multiple precision formats that require a predetermined amount of data per operation. The predetermined amount may be a non-integer multiple of a buffer storage capacity. The address generation unit can enable optimal memory bandwidth utilization by supporting full-capacity buffer loads while accommodating fractional buffer consumption requirements through circular buffer organization.

### CLAIM OF PRIORITY

The present application claims the benefit under 35 U.S.C. § 119(e) of U.S. Provisional Patent Application No. 63/770,903 filed Mar. 12, 2025, which is incorporated by reference herein.

### TECHNICAL FIELD

At least one embodiment pertains to techniques for efficient memory access in parallel processors through an address generation unit that enables matrix operations to span data stored in non-contiguous buffers in shared memory.

### BACKGROUND

Parallel processors can execute multiple computations simultaneously by distributing work across many processing units. Graphics processing units exemplify this architecture, with multiple streaming multiprocessors including processing elements, tensor cores, and memory hierarchies. These processors may organize matrix operations using specialized hardware units, such as tensor cores, that perform matrix multiply-accumulate operations on data stored in local shared memory. Memory management in these systems can involve coordinating between tensor memory access units, which load data from global memory in optimal chunk sizes, and matrix processing units, which consume this data for computation.

### BRIEF DESCRIPTION OF THE DRAWINGS

FIG. 1 is a block diagram of a system for shared memory optimization in a parallel processor, according to at least one embodiment;

FIG. 2 is a block diagram showing example components of an address generation unit within a tensor core, according to at least one embodiment;

FIG. 3A shows a flowchart of an example process of address generation for shared memory optimization, according to at least one embodiment;

FIG. 3B illustrates an example dual buffer address generation process, according to at least one embodiment;

FIG. 4A illustrates a matrix data layout example showing the relationship between tensor memory access operations and matrix multiply-accumulate operations, according to at least one embodiment;

FIG. 4B illustrates an example address generation, according to at least one embodiment;

FIG. 4C illustrates an example circular buffer wrap-around operation, according to at least one embodiment; and

FIG. 5 illustrates a flow diagram of an example method for shared memory optimization, according to at least one embodiment.

### DETAILED DESCRIPTION

Graphics processing unit (GPU) architectures rely heavily on matrix multiply-accumulate (MMA) operations for artificial intelligence (AI) workloads, particularly for deep neural networks and large language models. These operations are performed by specialized hardware units called tensor cores that are optimized to process matrix data from local shared memory. GPU architecture employs a memory hierarchy where tensor memory access (TMA) units serve as specialized direct memory access engines that efficiently move tensor data from global memory to shared memory in optimal data chunks. GPU matrix operations are typically designed around power-of-2 alignments where TMA loads of 128 bytes match MMA consumption patterns, enabling efficient memory bandwidth utilization and optimal performance when matrix operations consume data in multiples of the memory transaction size.

Advances in AI have driven adoption of mixed-precision arithmetic for improved performance and efficiency, creating a fundamental mismatch between memory load patterns and computation consumption patterns. MMA instructions can process 96 FP 4 elements or 64 FP6 elements, with each operation consuming 48 bytes. This leads to an efficiency ratio where 128-byte TMA loads divided by 48-byte MMA consumption equals 2.67 operations per load, resulting in fractional alignment that conventional approaches cannot handle efficiently.

Systems relying on reduced load sizes achieve only 75% bandwidth efficiency, creating suboptimal memory access patterns and inefficient sector requests that waste memory controller capabilities. When these systems reduce TMA loads to 96 bytes to align with two 48-byte operations, they sacrifice memory bandwidth and create suboptimal access patterns that reduce overall system performance. Additionally, forcing alignment by loading 128 bytes but wasting 32 bytes after two 48-byte operations results in 25% data waste and poor utilization of shared memory. This approach can result in significant resource waste when scaled across the thousands of operations required for modern AI workloads.

Software-only management approaches may coordinate buffer usage across operations, but they often lack the performance and efficiency needed for high-throughput AI applications. Systems employing software coordination can face issues such as complex synchronization requirements and performance overhead that reduce the effectiveness of specialized hardware. When these systems attempt to manage fractional consumption patterns, they may incur coordination overhead that disrupts the processing workflow. Additionally, software management without hardware support can waste computational resources and result in inadequate performance for demanding AI workloads, also lacking the ability to efficiently cross buffer boundaries at the hardware level.

Aspects of the present disclosure address these and other challenges in high-performance processors by providing a hardware-implemented address generation unit that generates addresses for a single matrix operation accessing data stored in non-contiguous buffers in shared memory. The address generation unit can store both a first buffer address and a second buffer address and coordinate access to both buffers for operations that require data spanning across buffer boundaries. The address generation unit can automatically detect when matrix operations need data from multiple buffers and generate the appropriate addresses for seamless access across buffer boundaries. Unlike systems that restrict operations to a single buffer or require software coordination, the address generation unit can execute matrix operations that span across buffers while maintaining optimal memory access patterns. Various embodiments can configure buffer addressing using dual-address programming, boundary detection systems, or circular buffer organization, depending on specific workload requirements.

A boundary detection framework can determine when matrix operations require data from multiple buffers based on operation size and remaining buffer space. Boundary detection may include data amount calculations where the required data exceeds remaining space in the current buffer, automatic address generation where hardware calculates addresses for both buffers, and seamless operation execution where buffer spanning appears transparent to software. The framework may trigger dual-buffer access, perform address calculation using hardware logic without software intervention, and coordinate data retrieval before executing matrix operations. This boundary detection framework can enable matrix operations to span across buffers when needed, ensuring optimal resource utilization.

A register field can be used for address interpretation based on operation mode selection, supporting both dimension offset calculations and next-buffer address programming. This register field can adapt to different operation requirements, maintain backward compatibility for existing software, and control addressing modes based on mode bit configuration triggered by various software programming approaches.

The system may provide granular control at multiple buffer management levels. Different operation types within the same processing context can use different addressing strategies. For example, aligned operations may use single-buffer addressing, while mixed-precision operations may use cross-buffer addressing. The system can also apply different strategies for different precision formats, buffer organizations, or even workload characteristics.

The system may implement a circular buffer organization where non-contiguous buffers enable arbitrary sequencing such that (i) any buffer can follow any other buffer, (ii) buffer sequences can wrap from the final buffer back to the first buffer, and (iii) buffer utilization can be optimized based on availability rather than sequential constraints. The system may also support multiple precision formats including 3xFP4 and 2xFP6 operations that both consume 48 bytes per operation.

The address generation unit may support buffer address programming where software can specify both current and next buffer addresses, mode bit control where a single bit determines address interpretation, and automatic coordination where hardware manages buffer boundary crossing without software intervention. The system may implement memory bandwidth optimization (e.g., through full 128-byte loads combined with 48-byte consumption patterns), achieving theoretical maximum efficiency while supporting fractional alignment requirements.

Advantages of the disclosed techniques include, but are not limited to: enhanced memory efficiency through selection of optimal addressing strategies based on buffer boundary detection; improved resource utilization by enabling matrix operations to span across buffers when needed, while using optimal memory access patterns and leveraging hardware coordination to minimize software overhead; reduced memory waste through efficient buffer utilization and elimination of alignment penalties, preventing accumulation of unused data in shared memory; better scalability for mixed-precision workloads by enabling different addressing strategies for different operation types and precision formats; increased operational flexibility through support for diverse workload requirements; and enhanced performance through hardware-accelerated buffer management and optimal memory bandwidth utilization.

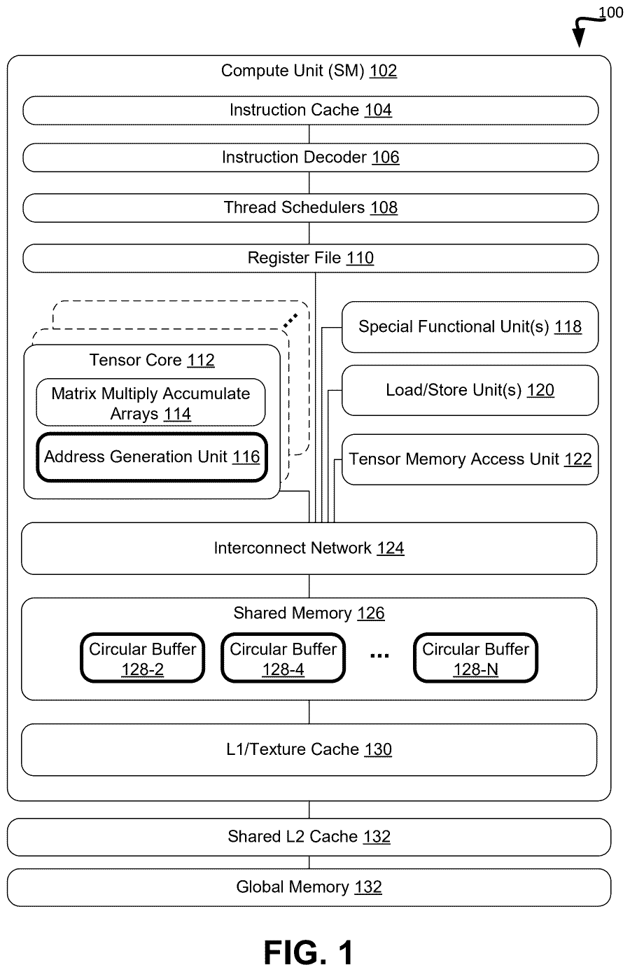

FIG. 1 is a block diagram of a system 100 for shared memory optimization in a parallel processor, according to at least one embodiment. An example of the system 100 is a graphics processing unit (GPU) that can execute multiple matrix operations simultaneously by distributing work across many processing units.

In at least one embodiment, the system 100 can include a compute unit 102 that serves as a streaming multiprocessor capable of executing multiple matrix operations concurrently, thus providing the system's parallel processing capabilities for matrix multiply-accumulate operations. The compute unit 102 may serve as an independent processing entity capable of executing multiple thread groups concurrently and may provide the system's parallel processing capabilities. The compute unit 102 may be configured to execute thread blocks as warps of parallel threads, where each thread block consists of at least one warp, and in some embodiments, each warp may include 32 threads executing in a Single-Instruction, Multiple-Thread (SIMT) architecture.

The compute unit 102 can include an instruction cache 104 that contains instructions to be executed by the compute unit 102. An instruction decoder 106 can convert matrix multiply-accumulate instructions into control signals for execution units, decoding instructions and distributing them to appropriate execution units, managing instruction flow and ensuring proper execution sequencing. Thread schedulers 108 can coordinate the execution of thread groups on the compute unit 102 and determine which operations execute at any given time while managing resource allocation. The thread schedulers 108 may receive tasks and schedule thread blocks for execution as warps of parallel threads, where each warp may execute multiple threads simultaneously in a SIMT architecture. The thread schedulers 108 may include dispatch units that can enable multiple different instructions from the same warp to be dispatched during each clock cycle, and may manage a plurality of different thread blocks by allocating them to different warps and dispatching instructions to various functional units.

The compute unit 102 can include a register file 110 that provides temporary storage for operands connected to data paths of functional units within the processing elements. The register file 110 can store intermediate results and matrix operation parameters during computation. The register file 110 may provide a set of registers for the processing elements and may provide temporary storage for operands connected to data paths of functional units of the processing elements. The register file 110 may be divided between each of the functional units such that each functional unit is allocated a dedicated portion of the register file 110, or it may be divided between different warps being executed by the compute unit 102.

A tensor core 112 can contain specialized matrix multiply-accumulate hardware that performs the actual matrix operations. The tensor core 112 can include matrix multiply accumulate arrays 114 that execute matrix multiplication and accumulation operations on input matrix data. An address generation unit 116 within the tensor core 112 can generate memory addresses for accessing matrix operand data from shared memory 126. The tensor core 112 may include multiple processing elements that can execute multiple thread groups in parallel, with each processing element capable of being pipelined and executing single-precision, double-precision, and mixed-precision operations. The tensor core 112 may be configured to perform deep learning matrix arithmetic, such as convolution operations for neural network training and inferencing, and may include fully-pipelined processing units that include floating point arithmetic logic units and integer arithmetic logic units that implement IEEE 754-2008 standard for floating point arithmetic.

The compute unit 102 can include special functional units 118 that perform specialized mathematical operations and load/store units 120 that handle memory access operations between different memory levels. The special functional units 118 may include arithmetic logic units (ALUs), floating-point units, and other specialized hardware for executing instructions. The special functional units 118 may perform special functions such as attribute evaluation, reciprocal square root, and may include tree traversal units configured to traverse hierarchical tree data structures and texture units configured to perform texture map filtering operations. A tensor memory access unit 122 can load tensor data from global memory 134 into the shared memory 126 in predetermined chunk sizes to maximize memory bandwidth utilization.

An interconnect network 124 can provide communication pathways between different components within the compute unit 102 and enables data transfer between processing elements and memory structures. The interconnect network 124 may be configured as a crossbar that can connect any functional unit to any register in the register file 110 and connect load/store units to the register file 110 and memory locations in shared memory 126.

The shared memory 126 can contain multiple circular buffers including circular buffer 128-2, circular buffer 128-4, through circular buffer 128-N, where N represents the total number of circular buffers in the shared memory 126. Each circular buffer can store a predetermined amount of tensor data, and its circular organization can enable matrix operations to access data across buffer boundaries. The shared memory 126 may be organized into fixed-size pages, where each page can be either fully allocated to a single operation or shared between multiple operations using enhanced addressing approaches. The shared memory 126 may include an array of on-chip memory that allows for data storage and communication between threads in the compute unit 102, providing storage capacity usable as a cache by programs while enabling high-throughput data streaming and high-bandwidth, low-latency access to frequently reused data.

The system 100 can include an L1/texture cache 130 that provides fast access to frequently used data and serves as an intermediate storage level between the shared memory 126 and higher-level memory structures. A shared L2 cache 132 can provide device-wide cache storage accessible across multiple compute units within the GPU. The L1/texture cache 130 may act as a coalescing buffer for memory accesses, gathering data requested by threads before delivery. The L1/texture cache 130 may be combined with shared memory functionality into a single memory block to provide optimal performance for both types of memory accesses, with capacity configurable for different uses depending on program requirements.

Global memory 134 can provide the largest storage capacity in the memory hierarchy and stores tensor data loaded into the shared memory 126 by the tensor memory access unit 122. The global memory 134 may reside off-chip and have higher latency compared to the shared memory 126 or the L2 cache 132.

The architecture can enable efficient matrix data access by allowing the address generation unit 116 to generate addresses that span multiple circular buffers within the shared memory 126, while the tensor memory access unit 122 continues to load data in optimal chunk sizes for maximum memory bandwidth utilization.

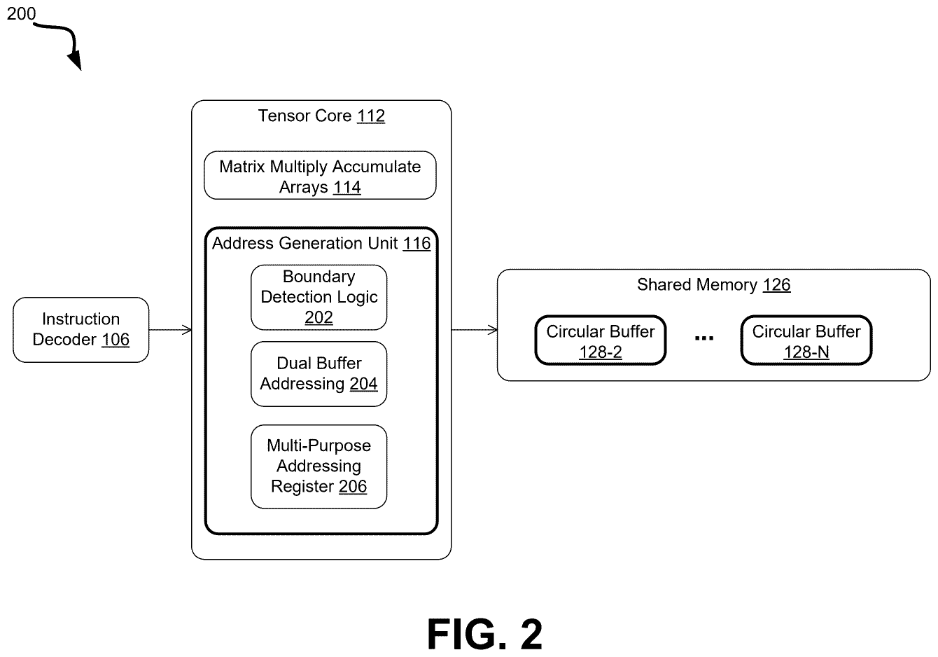

FIG. 2 is a block diagram showing example components 200 of the address generation unit within the tensor core 112, according to at least one embodiment. The diagram illustrates aspects of the address generation unit 116 that can enable matrix operations to span non-contiguous buffers in shared memory 126.

The instruction decoder 106 can send decoded matrix multiply-accumulate instructions to the tensor core 112, which processes these instructions through its enhanced address generation capabilities. The tensor core 112 can contain the matrix multiply accumulate arrays 114 that perform the actual matrix computations on data retrieved from the shared memory 126. The instruction decoder 106 may include dispatch units that can transmit instructions to the functional units and may enable multiple different instructions to be processed during each clock cycle.

The address generation unit 116 can include boundary detection logic 202, dual buffer addressing 204, and a multi-purpose addressing register 206 that enable buffer-spanning operations. Boundary detection logic 202 can determine when a single matrix operation requires more data than remains available in a current buffer by comparing the operation's data requirements to the remaining space in the buffer. This component can evaluate whether a matrix operation (e.g., a 48-byte matrix operation) can be satisfied within the current buffer or needs to span additional buffers. Dual buffer addressing 204 can generate address sets for accessing data from multiple buffers when the boundary detection logic 202 determines that an operation spans buffer boundaries, calculating addresses for both the current buffer portion and the next buffer portion of the required data, coordinating access to non-contiguous memory locations. A multi-purpose addressing register 206 can store addressing information interpretable in different modes depending on operation requirements. This register can contain one or more descriptor fields that specify either traditional leading dimension offsets or next buffer addresses for circular buffer operations. In some embodiments, the multi-purpose addressing register 206 may be part of the register file that provides temporary storage for operands and may be allocated as a dedicated portion for the address generation functionality.

The address generation unit 116 can communicate with the shared memory 126 to access data from the circular buffers. The shared memory 126 can contain circular buffers 128-2 through 128-N, enabling matrix operations to access data that spans across buffer boundaries using the addressing mechanism.

The boundary detection logic 202 can operate by comparing the required data amount for each matrix operation against the remaining space in the current buffer, automatically triggering dual buffer access when necessary. The dual buffer addressing 204 can then coordinate the retrieval of data portions from both buffers, presenting them as a single contiguous data stream to the matrix multiply-accumulate arrays 114.

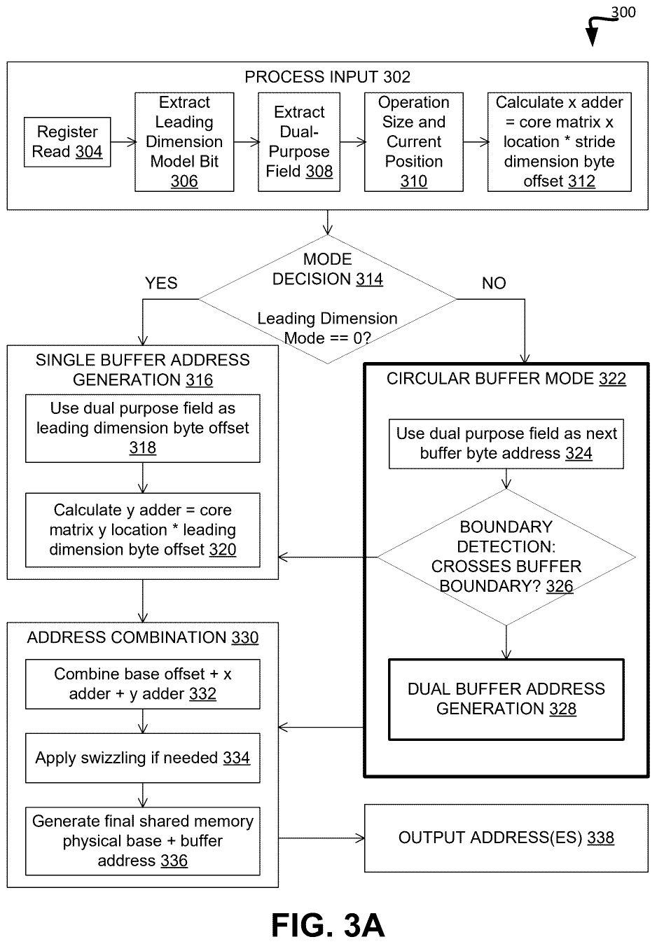

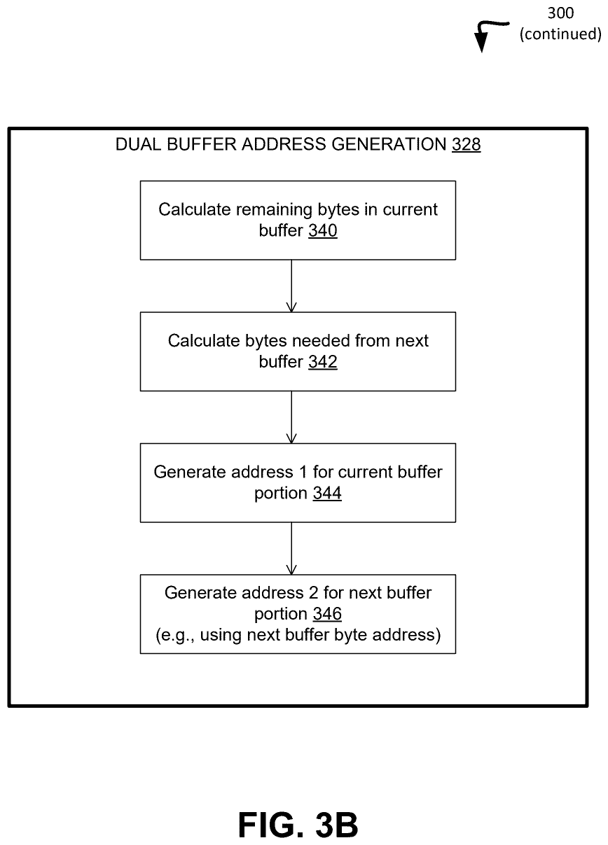

FIG. 3A shows a flowchart for an example process 300 of address generation for shared memory optimization, according to at least one embodiment. The process may correspond to a decision process implemented by the address generation unit 116 from FIG. 1 and the boundary detection logic 202 from FIG. 2 that translates virtual addresses to buffer locations within the shared memory 126.

The process can begin with process input 302, where the address generation unit 116 performs a register read 304 to extract addressing information from the multi-purpose addressing register 206. The address generation unit 116 can extract leading dimension mode bit 306 to determine the addressing mode, extract dual-purpose field 308 (which contains either offset information or next buffer addresses), and determine operation size and current position 310 for the matrix operation. The address generation unit 116 can calculate x adder 312 using the core matrix x location multiplied by the stride dimension byte offset.

At mode decision 314, the address generation unit 116 can determine whether the leading dimension mode equals zero. If the mode decision 314 results in “YES,” the address generation unit 116 can follow single buffer address generation 316, where the dual buffer addressing 204 uses the dual-purpose field as leading dimension byte offset 318 and calculates y adder 320 using the core matrix y location multiplied by the leading dimension byte offset.

If the mode decision 314 results in “NO,” the address generation unit 116 can enter circular buffer mode 322, where the dual buffer addressing 204 uses the dual-purpose field as next buffer byte address 324. The boundary detection logic 202 can then perform boundary detection 326 to determine whether the operation crosses a buffer boundary by comparing the operation size against the remaining buffer space.

When boundary detection 326 determines that no boundary crossing occurs, the system can proceed to address combination 330. When boundary detection 326 determines that boundary crossing occurs, the dual buffer addressing 204 can perform dual buffer address generation 328, as illustrated and described below in reference to FIG. 3B.

Address combination 330 can combine base offset plus the x adder plus the y adder 332, apply swizzling if needed 334, and generate final shared memory physical base plus buffer address 336. The process may conclude with output addresses 338 that enable access to the circular buffers within shared memory 126.

FIG. 3B illustrates an example dual buffer address generation process 328, according to at least one embodiment. The process may occur (or be triggered) when the boundary detection logic 202 determines that a matrix operation spans buffer boundaries. The dual buffer addressing 204 can calculate the remaining bytes in the current buffer 340 by determining how much data remains available in the current circular buffer within shared memory 126.

The dual buffer addressing 204 can calculate bytes needed from the next buffer 342 by subtracting the remaining bytes from the total operation requirement. The address generation unit 116 can generate address 1 for the current buffer portion 344 to access the available data in the current buffer, and generate address 2 for the next buffer portion 346 using the next buffer byte address to access the required additional data from the subsequent circular buffer.

This dual buffer address generation 328 can enable the tensor core 112 to perform matrix operations that span across the circular buffers 128-2 through 128-N in shared memory 126, while the tensor memory access unit 122 continues loading data in optimal chunk sizes for maximum bandwidth utilization.

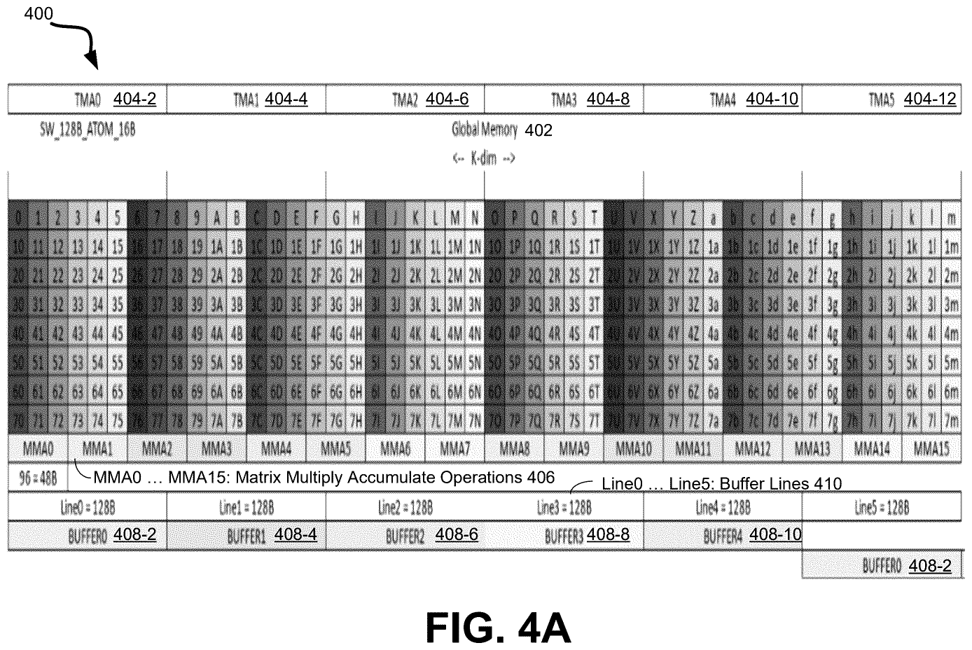

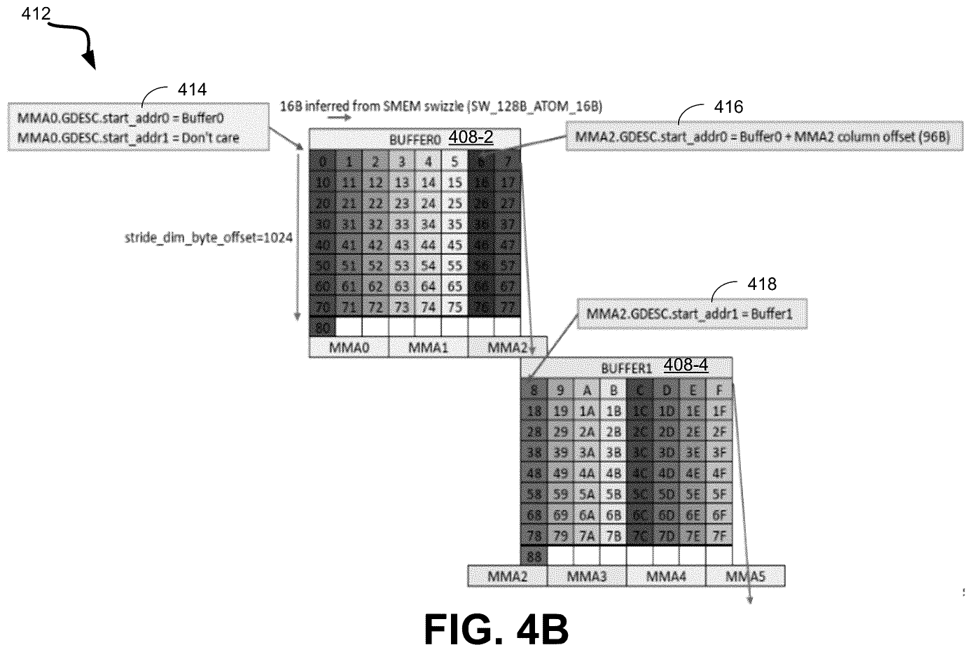

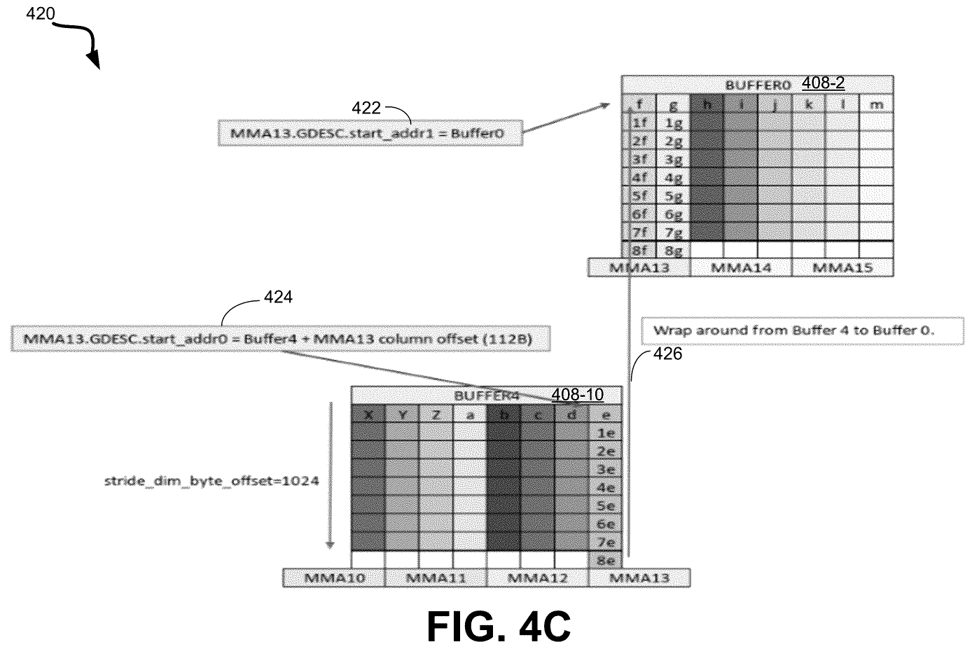

FIG. 4A illustrates a matrix data layout example 400 showing the relationship between tensor memory access operations and matrix multiply-accumulate operations, according to at least one embodiment. The diagram demonstrates how the tensor memory access unit 122 from FIG. 1 loads data and how the address generation unit 116 can enable matrix operations to span circular buffers in shared memory 126.

FIG. 4A shows an example organization of global memory 402 (e.g., the global memory 132) with TMA0 402-2 through TMA5 404-12 regions representing different tensor memory access loading zones. The global memory 402 can include a continuous data array with K-dimension elements, organized in an 8-row by multiple-column matrix format. Each cell corresponds to matrix elements stored in the global memory.

FIG. 4A also shows matrix multiply-accumulate operations MMA0 through MMA15 408, each consuming 48 bytes of data per operation. The diagram illustrates how these operations can map to the global memory layout, with each MMA operation processing a specific subset of the matrix elements.

FIG. 4A also demonstrates an example buffer organization within shared memory 126, showing six buffer lines 410 labeled Line 0 through Line 5, each containing 128 bytes of data. The buffers can be organized as BUFFER0 408-2 through BUFFER4 408-10, with the additional BUFFER0 408-2 section showing the circular wrap-around capability. Each buffer can store data loaded by the tensor memory access unit 122 from the corresponding global memory regions.

The diagram shows the fractional consumption pattern where each 128-byte buffer can support approximately 2.67 matrix operations (128 bytes÷48 bytes per operation), creating the boundary-spanning requirement that necessitates the address generation capabilities described herein. The circular buffer organization can enable operations like MMA13 to access data that spans from BUFFER4 408-10 back to BUFFER0 408-2, demonstrating the circular addressing mechanism implemented by the dual buffer addressing 204 from FIG. 2.

FIG. 4B illustrates an example address generation 412, according to at least one embodiment. The example shows how the address generation unit 116 can program buffer addresses for specific matrix operations. In some embodiments, a descriptor register (labeled GDESC) such as the multi-purpose addressing register 206 from FIG. 2 may be used for the address generation.

The example shows BUFFER0 408-2 containing an 8×8 matrix of elements, arranged in a grid pattern with a stride dimensional byte offset (stride_dim_byte_offset) equal to 1024. The buffer organization shows how matrix data (corresponding to MMA0, MMA1, and MMA2) may be stored within each 128-byte circular buffer in shared memory 126.

The example also shows programming examples for specific matrix operations. For MMA0, as indicated by the mapping 414, the first start address (GDESC. start_addr0) can point to BUFFER0 408-2, and the second start address (GDESC. start_addr1) may be marked as “Don't care” since MMA0 operates entirely within a single buffer. The addressing shows how the boundary detection logic 202 can determine that no buffer spanning is required.

For MMA2, as indicated by the mapping 416, GDESC. start_addr0 can be programmed to BUFFER0 408-2 with an MMA2 column offset of 96 bytes, positioning the operation near the buffer boundary. The GDESC. start_addr1 field can be programmed to BUFFER1 408-4, preparing for potential buffer spanning operations. The example shows BUFFER1 408-4 containing elements 8 through F and 18 through 7F, demonstrating how the next buffer in the circular sequence can contain additional matrix data. As indicated by the mapping 418, MMA2 operations can access data from both BUFFER0 408-2 and BUFFER1 408-4 when the 48-byte operation requirement exceeds the remaining space in BUFFER0 408-2.

FIG. 4C illustrates an example circular buffer wrap-around operation 420, according to at least one embodiment. The example demonstrates how matrix operations can transition from a final buffer back to a first buffer. The diagram illustrates the circular addressing capability of the address generation unit 116 and boundary detection logic 202 from FIG. 2.

BUFFER4 408-10 is shown containing elements x through e arranged in an 8×8 grid pattern, with stride_dim_byte_offset set to 1024. The diagram indicates that MMA10 through MMA13 operations can access data from BUFFER4, with MMA13 positioned at the buffer boundary where wrap-around 426 becomes necessary. BUFFER0 408-2 is shown containing matrix elements labeled f through m in the first row, with subsequent rows containing elements 1f through 8g. The buffer can be organized such that MMA13 and MMA14 operations can access this buffer data, with MMA13 specifically accessing data that spans beyond the current buffer capacity (of BUFFER4 408-10).

The circular wrap-around capability can enable continuous matrix processing without artificial boundaries, allowing the tensor memory access unit 122 to maintain optimal 128-byte loading patterns while the address generation unit 116 handles fractional consumption across buffer boundaries within the shared memory 126.

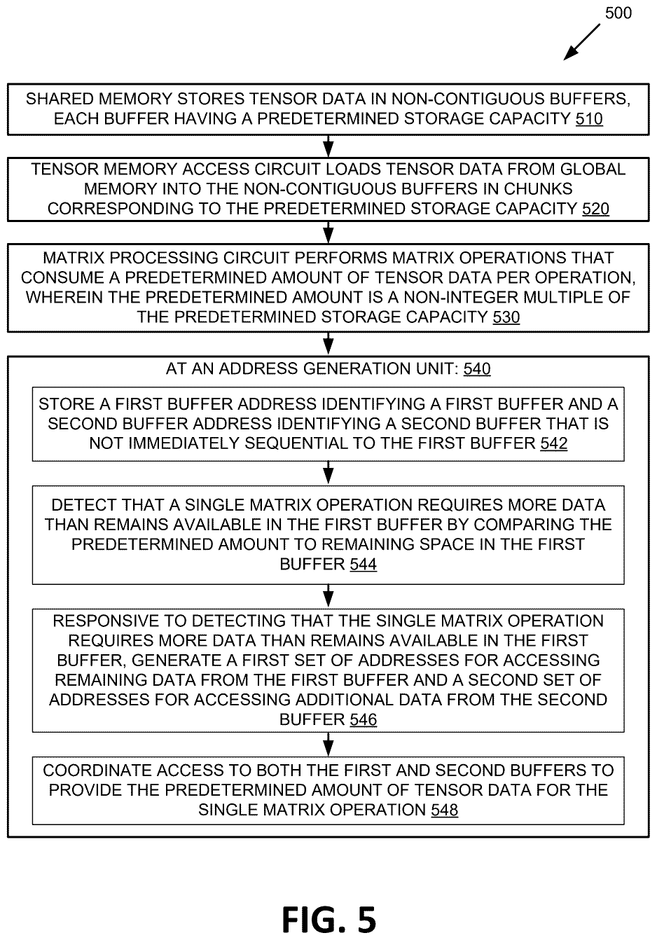

FIG. 5 illustrates a flow diagram of an example method 500 for shared memory optimization, according to at least one embodiment. The method can be implemented by components of the system 100 to enable matrix operations that can span non-contiguous buffers in shared memory 126.

At block 510, the shared memory 126 can store tensor data in non-contiguous buffers, each buffer having a predetermined storage capacity. The shared memory 126 can contain circular buffers 128-2 through 128-N, where each buffer stores 128 bytes of tensor data as demonstrated in FIG. 4A. The tensor memory access unit 122 can load this data from global memory 134 in optimal chunk sizes to maximize memory bandwidth utilization.

At block 520, the tensor memory access unit can load tensor data from global memory into the non-contiguous buffers in chunks corresponding to the predetermined storage capacity. The tensor memory access unit 122 can perform these loading operations, transferring 128-byte chunks from the global memory 134 regions labeled TMA0 through TMA5 in FIG. 4A into the corresponding buffers within shared memory 126. This loading pattern can maintain optimal memory bandwidth by using full 128-byte transactions rather than smaller, less efficient transfers.

At block 530, the matrix processing circuit can perform matrix operations that consume a predetermined amount of tensor data per operation. The predetermined amount can be a non-integer multiple of the predetermined storage capacity. The tensor core 112 containing matrix multiply-accumulate arrays 114 can execute these operations, with each matrix operation consuming 48 bytes of data. This creates the fundamental fractional relationship of 128 bytes÷48 bytes=2.67 operations per buffer, as illustrated across the MMA0 through MMA15 operations in FIG. 4A.

In some embodiments, the address generation unit 116 may include a register having a field that is selectively interpretable as either a second buffer address or a dimension offset based on an operation mode, as described in the multi-purpose addressing register 206 from FIG. 2. The register field may contain dual-purpose information where bits 29-16 can represent either a traditional leading dimension byte offset in legacy mode or a next buffer start address in circular buffer mode, controlled by a mode bit.

At block 540, components within the address generation unit 116 can store addressing information to enable buffer spanning operations. The address generation unit 116 can store a first buffer address identifying a first buffer and a second buffer address identifying a second buffer that is not immediately sequential to the first buffer 542. The multi-purpose addressing register 206 can implement this dual-address storage capability, as demonstrated in FIG. 4B where MMA2.GDESC.start_addr1 is programmed to Buffer1 while maintaining Buffer0 as the primary buffer.

In some embodiments, the boundary detection logic 202 may determine that a single matrix operation requires data from multiple buffers when a data amount for the single matrix operation exceeds the remaining space in a current buffer. The boundary detection may involve comparing the 48-byte operation requirement against available buffer space and triggering dual-buffer access when the requirement cannot be satisfied within the current buffer alone.

At block 544, the boundary detection logic 202 can detect that a single matrix operation requires more data than remains available in the first buffer by comparing the predetermined amount to the remaining space in the first buffer. The boundary detection logic 202 can evaluate whether the 48-byte operation requirement exceeds the available space in the current buffer position.

In some embodiments, the boundary detection logic 202 may be configured to trigger automatic address generation for accessing the multiple buffers, implementing the dual buffer address generation 328 process shown in FIG. 3B when a boundary crossing is detected.

At block 546, responsive to detecting that the single matrix operation requires more data than remains available in the first buffer, the dual buffer addressing 204 can generate a first set of addresses for accessing remaining data from the first buffer and a second set of addresses for accessing additional data from the second buffer. The dual buffer addressing 204 can calculate that 32 bytes can be retrieved from the current buffer position in BUFFER4, while the remaining 16 bytes need to be accessed from BUFFER0.

In some embodiments, the address generation unit 116 may be configured to support loading 128 bytes into each buffer and consuming 48 bytes per matrix operation, creating an optimal access pattern that enables both maximum memory bandwidth utilization and efficient matrix operation execution without data waste.

At block 548, the address generation unit 116 can coordinate access to both the first and second buffers to provide the predetermined amount of tensor data for the single matrix operation. The address generation unit 116 can present the distributed data as a single contiguous 48-byte stream to the matrix multiply-accumulate arrays 114, enabling seamless matrix operations despite the physical distribution across non-contiguous buffers.

In some embodiments, the system 100 may organize the non-contiguous buffers as a circular buffer where a final buffer can be followed by a first buffer, as demonstrated in FIG. 4C where BUFFER4 wraps around to BUFFER0. This circular organization may enable continuous operation without running out of buffers and may support streaming data processing applications.

In some embodiments, the address generation unit 116 may be configured to support matrix operations that process multiple precision formats requiring 48 bytes of data, including 3xFP4 operations consuming 96 FP4 elements and 2xFP6 operations consuming 64 FP6 elements. Both precision formats may create the same 2.67 operations-per-buffer ratio that necessitates the buffer-spanning capability.

In some embodiments, the address generation unit 116 may enable optimal memory bandwidth utilization by supporting full 128-byte loads while accommodating 48-byte matrix operation requirements, achieving theoretical maximum efficiency while supporting fractional alignment requirements without forcing artificial constraints on memory access patterns.

The method 500 can enable the system 100 to achieve optimal memory bandwidth utilization by supporting full 128-byte loads while accommodating the 48-byte matrix operation requirements, eliminating the 32-byte waste that would occur with traditional single-buffer allocation approaches and improving memory utilization efficiency.

Other variations are within the spirit of the present disclosure. Thus, while the disclosed techniques are susceptible to various modifications and alternative constructions, certain illustrated embodiments thereof are shown in drawings and have been described above in detail. It should be understood, however, that there is no intention to limit the disclosure to the specific form or forms disclosed, but on the contrary, the intention is to cover all modifications, alternative constructions, and equivalents falling within the spirit and scope of the disclosure, as defined in the appended claims.

Use of terms “a” and “an” and “the” and similar referents in the context of describing disclosed embodiments (especially in the context of the following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. In at least one embodiment, use of the term “set” (e.g., “a set of items”) or “subset” unless otherwise noted or contradicted by context, is to be construed as a non-empty collection comprising one or more members. Further, unless otherwise noted or contradicted by context, the term “subset” of a corresponding set does not necessarily denote a proper subset of the corresponding set, but the subset and corresponding set may be equal.

Conjunctive language, such as phrases of the form “at least one of A, B, and C,” or “at least one of A, B and C,” unless specifically stated otherwise or otherwise clearly contradicted by context, is otherwise understood with context as used in general to present that an item, term, etc., may be either A or B or C, or any non-empty subset of the set of A and B and C. For instance, in the illustrative example of a set having three members, conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, the term “plurality” indicates a state of being plural (e.g., “a plurality of items” indicates multiple items). In at least one embodiment, a number of items in a plurality is at least two but can be more when so indicated either explicitly or by context. Further, unless stated otherwise or otherwise clear from context, the phrase “based on” means “based at least in part on” or “based at least on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under the control of one or more computer systems configured with executable instructions and is implemented as code (e.g., executable instructions, one or more computer programs, or one or more applications) executing collectively on one or more processors, by hardware, or combinations thereof. In at least one embodiment, code is stored on a computer-readable storage medium, for example, in the form of a computer program including a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause the computer system to perform the operations described herein. In at least one embodiment, a set of non-transitory computer-readable storage media includes multiple non-transitory computer-readable storage media, and one or more of the individual non-transitory storage media of the multiple non-transitory computer-readable storage media lack all of the code while the multiple non-transitory computer-readable storage media collectively store all of the code. In at least one embodiment, executable instructions are executed such that different instructions are executed by different processors—for example, a non-transitory computer-readable storage medium stores instructions, and a main central processing unit (“CPU”) executes some of the instructions while a graphics processing unit (“GPU”) executes other instructions. In at least one embodiment, different components of a computer system have separate processors, and different processors execute different subsets of instructions.

Accordingly, in at least one embodiment, computer systems are configured to implement one or more services that singly or collectively perform operations of the processes described herein, and such computer systems are configured with applicable hardware and/or software that enable the performance of operations. Further, a computer system that implements at least one embodiment of the present disclosure is a single device and, in another embodiment, is a distributed computer system including multiple devices that operate differently such that the distributed computer system performs the operations described herein and such that a single device does not perform all operations.

Use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

All references, including publications, patent applications, and patents, cited herein are hereby incorporated by reference to the same extent as if each reference were individually and specifically indicated to be incorporated by reference and were set forth in its entirety herein.

In the description and claims, the terms “coupled” and “connected,” along with their derivatives, may be used. It should be understood that these terms may not be intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, in some embodiments, it may be appreciated that throughout the specification, terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers, or other such information storage, transmission, or display devices.

In a similar manner, the term ‘“processor” may refer to any device or portion of a device that processes electronic data from registers and/or memory and transforms that electronic data into other electronic data that may be stored in registers and/or memory. As non-limiting examples, a “processor” may be a CPU or a GPU. A “computing platform” may include one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously, or intermittently. In at least one embodiment, the terms “system” and “method” are used herein interchangeably insofar as a system may embody one or more methods, and methods may be considered a system.

In the present document, references may be made to obtaining, acquiring, receiving, or inputting analog or digital data into a subsystem, computer system, or computer-implemented machine. In at least one embodiment, a process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from a providing entity to an acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface, or an inter-process communication mechanism.

Although descriptions herein set forth example embodiments of the described techniques, other architectures may be used to implement the described functionality and are intended to be within the scope of this disclosure. Furthermore, although specific distributions of responsibilities may be defined above for purposes of description, various functions and responsibilities might be distributed and divided in different ways, depending on circumstances.

Furthermore, although the subject matter has been described in language specific to structural features and/or methodological acts, it is to be understood that the subject matter claimed in the appended claims is not necessarily limited to the specific features or acts described. Rather, the specific features and acts are disclosed as exemplary forms of implementing the claims.

What is claimed is:

1. A processing device comprising:
an address generation unit to generate addresses for a single matrix operation that processes data spanning non-contiguous buffers in shared memory.

2. The processing device of claim 1, wherein the address generation unit is to store an address of a first buffer and an address of a second buffer and coordinate access to both buffers for the single matrix operation.

3. The processing device of claim 2, wherein the address generation unit includes a register having a field that specifies either the address of the second buffer or a leading dimension offset for an operand of the single matrix operation.

4. The processing device of claim 3, wherein the register further comprises a mode bit that determines whether the field is the address of the second buffer or the leading dimension offset for the operand of the single matrix operation.

5. The processing device of claim 2, further comprising one or more circuits to program the address of the first buffer and the address of the second buffer.

6. The processing device of claim 1, further comprising a boundary detection logic to:
detect that a data amount for the single matrix operation exceeds a remaining space in a current buffer; and
trigger the address generation unit to generate the addresses for accessing the non-contiguous buffers in response to the data amount exceeding the remaining space.

7. The processing device of claim 1, further comprising a tensor memory access unit to load data into the non-contiguous buffers.

8. The processing device of claim 7, wherein the tensor memory access unit is further to load data chunks of a first predetermined size into the non-contiguous buffers, the processing device further comprising:
a matrix processing circuit to perform matrix operations consuming data chunks of a second predetermined size, wherein the second predetermined size is a non-integral fraction of the first predetermined size.

9. The processing device of claim 1, wherein the processing device is a graphics processing unit and the shared memory is on-chip memory local to matrix processing units.

10. The processing device of claim 1, wherein the address generation unit is to support matrix operations that process multiple precision formats that require a predetermined amount of data.

11. The processing device of claim 10, wherein the multiple precision formats include 3xFP4 operations consuming 48 bytes and 2xFP6 operations consuming 48 bytes.

12. A processing device comprising:
shared memory to store tensor data in non-contiguous buffers, each buffer having a predetermined storage capacity;
a tensor memory access unit to load tensor data from global memory into the non-contiguous buffers in chunks corresponding to the predetermined storage capacity;
a matrix processing circuit to perform matrix operations that consume a predetermined amount of tensor data per operation, wherein the predetermined amount is a non-integer multiple of the predetermined storage capacity; and
an address generation unit, coupled to the shared memory, the address generation unit to:
store a first buffer address identifying a first buffer and a second buffer address identifying a second buffer that is not immediately sequential to the first buffer;
detect that a single matrix operation requires more data than remains available in the first buffer by comparing the predetermined amount to remaining space in the first buffer;
responsive to detecting that the single matrix operation requires more data than remains available in the first buffer, generate a first set of addresses for accessing remaining data from the first buffer and a second set of addresses for accessing additional data from the second buffer; and
coordinate access to both the first and second buffers to provide the predetermined amount of tensor data for the single matrix operation.

13. The processing device of claim 12, wherein the address generation unit comprises a boundary detection logic to detect that the single matrix operation requires more data than remains available in the first buffer by calculating whether the predetermined amount exceeds the remaining space in the first buffer.

14. The processing device of claim 13, wherein the boundary detection logic is to trigger the address generation unit to generate the first set of addresses and the second set of addresses.

15. The processing device of claim 12, wherein the address generation unit includes a register comprising a field that specifies either the second buffer address or a leading dimension offset for an operand of the single matrix operation.

16. The processing device of claim 15, the register further comprises a mode bit that determines whether the field is the address of the second buffer or the leading dimension offset for the operand of the single matrix operation.

17. The processing device of claim 12, wherein the matrix processing circuit is to perform single matrix operations using multiple precision formats that each consume the predetermined amount of tensor data.

18. The processing device of claim 17, wherein the multiple precision formats include 3xFP4 operations and 2xFP6 operations.

19. The processing device of claim 12, wherein the address generation unit is to enable programming both the first buffer address and the second buffer address.

20. The processing device of claim 12, wherein the predetermined storage capacity is 128 bytes and the predetermined amount of tensor data per operation is 48 bytes.
